(19) United States
(12) Patent Application Publication
(10) Pub. No.: US 2016/0235101 A1
(43) Pub. Date: Aug. 18, 2016

(54) Sicillian Hot Dog Sauce

(71) Applicant: Grace Marie Ventura, Ivanhoe, NC (US)

(72) Inventor: Grace Marie Ventura, Ivanhoe, NC (US)

(21) Appl. No.: 14/624,381

(22) Filed: Feb. 17, 2015

(51) Int. Cl. A23L 1/226

(52) U.S. Cl. CPC A23L 1/226; A23V 2002/00

(57) ABSTRACT

The present invention relates to natural ingredient based food sauce. The invention presents a method for preparing temperature-sensitive, shelf-stable, tomato-based sauce with fresh and natural ingredients such as Onion, Olive oil, Black pepper, fresh tomatoes, water, salt, sugar and the like. Other ingredients, such as Franks Red Hot Sauce and ground Hamburg are then combined.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention relates to natural ingredient based food sauce. More specifically this food sauce is a unique combination of ingredients resulting in a tasty and consistent tomato based sauce for sausage dishes and the like.

(2) Background of Invention

Sauces have traditionally been a combination of the few ingredients. Historically, the prior art food recipes and combination of ingredients relating to tomato based sauces were often just simple combinations that offered little variation of taste from dish to dish. Also, many of the prior art in sauces did not address the methods, but stayed more with the ingredients.

Sauces for the sausage dishes available in the market include nuts, vinegar, water, oil and salt. Hot dogs have long been associated with one another like doughnuts and coffee, peanut butter and jelly, bacon and eggs. A hot dog is a meat product typically consumed in a soft bread bun that is used to contain a hot dog. The bun allows the user to grasp the hot dog without having grease and/or condiments spill on the consumer's hands. The typical hot dog is cylindrical in shape and fits within a slit opening in the bun. The hot dog is a sausage type of meat product that may be made of beef, pork, chicken or turkey. Further the consumer may easily handle a hot dog within the bun for consumption without issues involving the greasiness or heat that may be associated with the hot dog. The hot dog is usually adorned with condiments during consumption such as ketchup, relish, mustard, onions or pickles. Although commonly used with a hot dog the hot dog bun is also used with other sausage-type of meats such as frankfurters, hot links or Italian sausage.

Hotdogs have also been served with chili and/or cheese to add flavor and variety to the taste thereof. Hotdogs are occasionally sold on a stick after being dipped in cornbread batter and deep-fried in oil thus creating the corndog.

The conventional low acid sauces presently available offer the consumer a good dairy-like taste, body, and mouth feel, but because of their low pH, they can easily become spoiled by microbial growth and create an unpleasant and potentially dangerous culinary experience for the consumer if handled or packaged improperly. To reduce the potential for bacterial spoilage, government regulations pertaining to food safety require that low acid products, such as conventional low acid cheese sauces, must be subjected to severe heat sterilization procedures under conditions sufficient to kill C. botulinum and other pathogens.

Accordingly it is desirable to provide a product made from readily available natural ingredients, which is easy to prepare and has the unique taste and advantages of the sauce of the present invention.

### BRIEF SUMMARY OF THE INVENTION

The invention presents a method for preparing temperature-sensitive, shelf-stable, tomato-based sauce with fresh and natural ingredients such as Onion, Olive oil, Black pepper, fresh tomatoes, water, salt, sugar and the like. Other ingredients, such as Franks Red Hot Sauce and ground Hamburg are then combined.

The combination is heat treated. The resulting Tomato-based food products have a texture, appearance, flavor, and nutrient quality that are substantially the same as their freshly prepared counterparts. Still other features and advantages of the present invention will become apparent from the following detailed description, which illustrates by way of example, the principles of the invention.

### DETAILED DESCRIPTION OF THE INVENTION

The description that follows includes exemplary devices, methods, systems, techniques and instruction sequences products that embody techniques of the present inventive subject matter. However, it should be understood that the described embodiments may be practiced without these specific details. Well-known instruction instances, protocols, structures and techniques have not been shown in detail in order not to obfuscate the description.

Embodiments of the present invention are generally related to a hot dog sauce and methods of manufacturing the same. More specifically, embodiments of the present invention relate to a hot dog sauce having an improved flavor resulting from natural and healthy ingredients, and methods of manufacturing the same for commercial purposes. In many embodiments of the present invention, in its basic form, the hot dog sauce comprises a major part of onions, water, sugar, tomato paste, olive oil, and black pepper. Alternatively, in certain embodiments, additional ingredients such as: salt, Franks Red Hot Sauce and Ground Hamburg, combinations thereof, or the like, may also be provided.

In another preferred embodiment of the present invention, hot dog sauce in accordance with the present invention comprises on a weight basis 20-30% yellow onion, 5-10% Olive oil, 1-2% black pepper, 1-2% salt, 5-10% Sugar, 30-40% Tomato (crushed), 20-30% Franks Red Hot sauce, 5-10% Ground Hamburg and 10-20% water.

To prepare a hot dog sauce in accordance with embodiments of the present invention, the following method may be utilized. In one embodiment of the present invention, a method of preparation of Hot dog sauce comprises: (a) cutting the yellow onions in a length; (b) place onions in a frying pan with the olive oil on medium heat, when onions are soft then sprinkle with black pepper and salt; (c) In another pot place crushed tomato on low heat and then add Contadina tomato paste with hot water; (d) Now on simmer low heat add Franks Red Hot sauce and sugar in above pan contains tomato crush; (e) In a large frying pan put ground Hamburg and water till it becomes brown; at last add onions to sauce and keeps simmer medium heat till it thickens. The sweet onion sauce is either ready for consumption, canning, jarring, storage or the like.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations or structures described herein as a single instance. Finally, boundaries between various components and operations are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I/We claim:

1. A Sicilian Hot Dog Sauce, comprising the following ingredients:
a) 20-30% yellow onion;
b) 5-10% olive oil;
c) 1-2% black pepper;
d) 1-2% salt;
e) 5-10% sugar;
f) 30-40% tomato (crushed);
g) 20-30% Franks Red Hot sauce;
h) 5-10% ground hamburger; and
i) 10-20% water

2. A method of preparing a Sicilian Hot Dog Sauce, comprising the steps of:
(a) Cutting the yellow onions in a length;
(b) Frying onions in a pan with the olive oil on medium heat, when onions are soft then sprinkle with black pepper and salt;
(c) Heating crashed tomatoes in second pot on low heat;
(d) Adding Contadina tomato paste with hot water into the second pot;
(e) Heating on simmer low heat add Franks Red Hot sauce and sugar in the second pan containing tomato crush;
(f) Frying in a large pan ground hamburger and water till it becomes brown;
(g) Adding onions to sauce and keeping simmer medium heat till it thickens.
(h) Placing the resulting Sicilian Hot Dog Sauce into canning, jarring, and storage means.
